(19) United States
(12) Patent Application Publication
(10) Pub. No.: US 2007/0028140 A1
(43) Pub. Date: Feb. 1, 2007

(54) Information processing method and information processing device

(76) Inventor: Atsushi Takeda, Yokohama-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/493,833

(22) Filed: Jul. 27, 2006

(30) Foreign Application Priority Data
Jul. 28, 2005 (JP) 2005-219178

(51) Int. Cl. G06F 11/00

(52) U.S. Cl. 714/6

(57) ABSTRACT

According to one embodiment, an information processing method comprising reading information of a data frame from an external to store the information in a memory, the data frame being defined to include an error detecting parity code, checking by use of the error detecting parity code whether or not there is an error in the information of the data frame stored in the memory, transferring, to a host, the information of the data frame stored in the memory, when any error is not found by the checking, and checking by use of the error detecting parity code whether or not there is an error in the information of the data frame transferred to the host, and retransferring the information of the data frame from the memory to the host, when the error is found.

### CROSS-REFERENCE TO RELATED APPLICATIONS

This application is based upon and claims the benefit of priority from Japanese Patent Application No. 2005-219178, filed Jul. 28, 2005, the entire contents of which are incorporated herein by reference.

### BACKGROUND

1. Field

One embodiment of the invention relates to an information processing method and an information processing device in which information of a data frame having an error detecting parity code attached thereto is transferred to an external device.

2. Description of the Related Art

A storage capacity of an information storage medium is increased year after year. In, for example, an optical disk field, the capacity has increased from a compact disc (CD) to a digital versatile disc (DVD) and a further high-density DVD (HD DVD). To information to be recorded in such large-capacity disk, an error correction code (ECC) is attached. Even when there is a little error in the information read from the disk, the error can be corrected. The information in which the error has been corrected is once stored in a memory before transferred to an external device (host such as a personal computer).

In addition, in a data section of CD-ROM/DVD/HD DVD, an error detection code (EDC) is added, as a parity code for detecting the error of the whole data sector, to the end of the data sector (data frame). This EDC is a cyclic redundancy check (CRC) of, for example, 32 bits, and the error can be detected by the code. The error of data reproduced from the disk is corrected by the ECC. However, in a case where the number of the errors is large, and the errors cannot be corrected, an error flag remains which indicates that the correction is impossible. In this case, the data is read again from the disk. On the other hand, in a case where the error correction is not impossible, and any error flag is not left, it is checked by the EDC whether or not there is erroneous correction. If the erroneous correction is detected during this check, the data is read again from the disk.

For example, in the DVD, the information in which the error is to be corrected by the ECC is formed into the data frame, the error detecting parity code (EDC) is attached to the end of the frame, and it can be checked whether or not the information of the data frame is correct after the error correction by the ECC (whether or not there is not any erroneous correction). The information of the data frame, which is judged to be correct by the check using this EDC, is stored once in the memory, and thereafter transferred to the external device (host).

Here, information (corrected data stored in the memory) is read from the disk, appropriately subjected to the ECC correction, and judged to be correct by the parity check using the EDC. Even the information might be changed in a data transfer path, an interface or the memory itself, in a case where the information is transferred to the external device (host device). There is a conventional technology to detect the changed data in the memory (see Jpn. Pat. Appln. KOKAI Publication No. 5-257884).

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing an information processing device according to one embodiment of this invention;

FIG. 2 is an exemplary diagram showing an example of a constitution of a data frame including an error detecting parity code (EDC) in an end thereof;

FIG. 3 is an exemplary flowchart showing an information processing method according to the embodiment of this invention;

FIG. 4 is an exemplary flowchart showing a specific example (memory clock frequency change) of processing to change a memory access system in the processing method of FIG. 3;

FIG. 5 is an exemplary flowchart showing another specific example (memory storage address change) of the processing to change the memory access system in the processing method of FIG. 3; and

FIG. 6 is an exemplary flowchart showing a specific example (memory access timing change) of the processing to change the memory access system in the processing method of FIG. 3.

### DETAILED DESCRIPTION

Various embodiments according to the invention will be described hereinafter with reference to the accompanying drawings. In general, according to one embodiment of the invention, an information processing method comprising reading information of a data frame from an external to store the information in a memory, the data frame being defined to include an error detecting parity code; checking by use of the error detecting parity code whether or not there is an error in the information of the data frame stored in the memory; transferring, to a host, the information of the data frame stored in the memory, when any error is not found by the checking; and checking by use of the error detecting parity code whether or not there is an error in the information of the data frame transferred to the host, and retransferring the information of the data frame from the memory to the host, when the error is found.

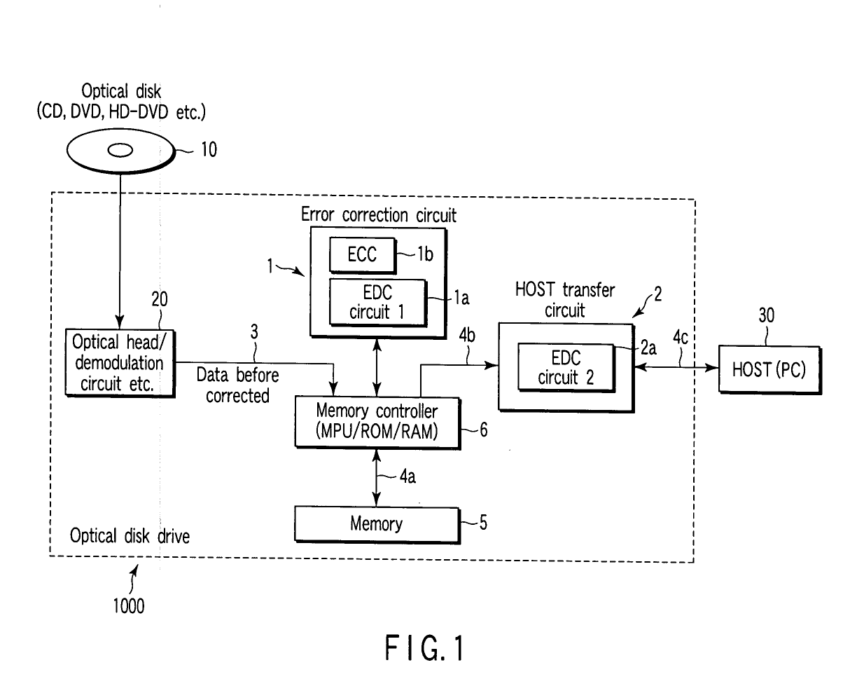

FIG. 1 is an exemplary block diagram showing an information processing device according to an embodiment of this invention. There are various optical disks such as a CD-ROM, a DVD and an HD DVD. Here, the DVD will be described as an example. Information recorded in a DVD disk (DVD-ROM, DVD+R, DVD+RW, DVD-RAM or the like) 10 is read via an optical head/demodulation circuit 20 or the like, a read demodulated signal (data before error correction) is sent to a memory controller 6 via a transmission path 3, and the signal is once stored in a memory (semiconductor memory such as a DRAM) 5. The memory controller 6 can be constituted of a micro processing unit (MPU) including a work RAM and a firmware ROM. It is to be noted that this MPU also controls an error correction circuit 1 or a host transfer circuit 2 described later.

The sent data before the error correction is processed by an ECC processing circuit 1b of the error correction circuit 1, and an error is appropriately corrected if any. Moreover, a first EDC circuit 1a checks whether or not there is an error in a corrected data frame (data sector) as a whole (whether or not there is any erroneous correction by an ECC. If there is not any error in the whole data (i.e., the ECC correction is correctly performed, and a result of EDC check is OK), the correct data frame information is stored once in a predetermined address of the memory 5.

Thereafter, the correct data frame information (both of the ECC check and the EDC check are OK) stored in the memory 5 is read out by the memory controller 6 via a memory interface 4a in a predetermined timing, and sent to the host transfer circuit 2 via a transfer path 4b.

The host transfer circuit 2 has a second EDC circuit 2a. Even when it has been checked by the first EDC circuit 1a that the data frame information in the memory 5 is correct, changed data (due to a certain factor) cannot be checked with respect to the data read out once from the memory 5. To solve the problem, when the data frame information is sent to an external host device (personal computer PC or the like) 30, the second EDC circuit 2a checks the data by the EDC again. The information (i.e., information having a high reliability) judged to have no problem as a result of this re-check is sent to the host device 30 via a data transmission cable 4c, and utilized in the host.

In the constitution of FIG. 1, the constituting elements 1 to 6 and 20 can be incorporated in an optical disk drive 1000. The constituting elements 1 to 4 and 6 (or the constituting elements 1 to 6) can be integrated in a large-scale integrated circuit (LSI). In the LSI, a wiring line of a data transmission system can be reduced and shortened, and there is a possibility that the data can easily be inhibited from being changed in the middle of the path. However, since an operation clock frequency is very high with a high data transfer rate, and power consumption of the LSI is reduced, a power voltage drops, and a signal level accordingly decreases. Therefore, the LSI is easily influenced even by little unexpected noise. Therefore, even in a case where this invention is carried out as the LSI, it is effective to dispose the second EDC circuit 2a. Especially in an embodiment in which the LSI including the second EDC circuit 2a is an IC separate from that of the memory 5, and the circuits are connected to each other via the memory interface 4a, a possibility of changing the data transmitted through the memory interface 4a cannot be ignored.

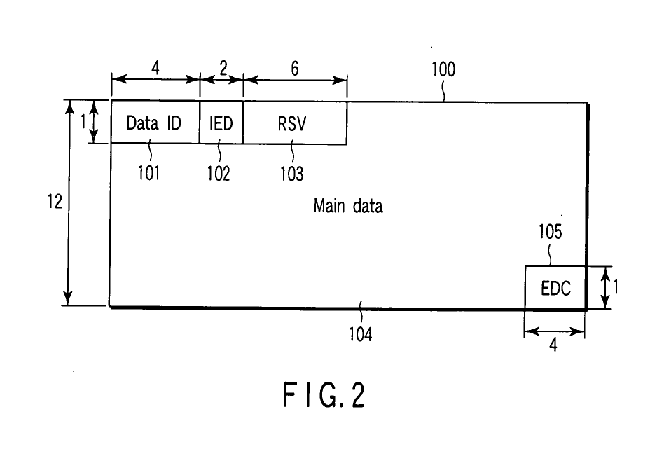

FIG. 2 is a diagram showing an example of a constitution of a data frame (data sector) including an error detecting parity code (EDC) in an end thereof. Here, a constitution of a data frame 100 for use in a DVD is illustrated, and a view of the EDC is the same in both of a CD-ROM and an HD DVD. Information in the data frame 100 is constituted as follows. That is, to main data 104, there are added: a 4-byte data ID 101; a 2-byte data ID error detection code IED 102; and 6-byte reserved data RSV 103 (usable for storing copy right management information and the like). Moreover, a 4-byte error detection code EDC 105 is generated and added to the whole data to constitute the data frame 100 of one sector.

This data frame (data sector) 100 has a size of 2064 bytes (172 bytes×12 rows) including 2048 bytes of the main data 104, and is an information unit having a size larger than an ECC block size of, for example, 32 KB.

The EDC 105 is, for example, a 4-byte check code attached to 2060 bytes in the data frame (data sector) 100 before scrambled. Here, assuming that the most significant bit (MSB) of the top byte of the ID field 101 is b16511, and the least significant bit (LSB) of the final byte of the EDC 105 is b0, the error detecting parity code EDC 105 can be represented, for example, as follows (in the DVD):
EDC(x)=Σ⁰ᵢ₌₃₁bixⁱ=I(x)mod|g(x)|,

wherein I(x)=Σ³²ᵢ₌₁₆₅₁₁ bi xⁱ; g(x)=x³²+x³¹+x⁴+1.

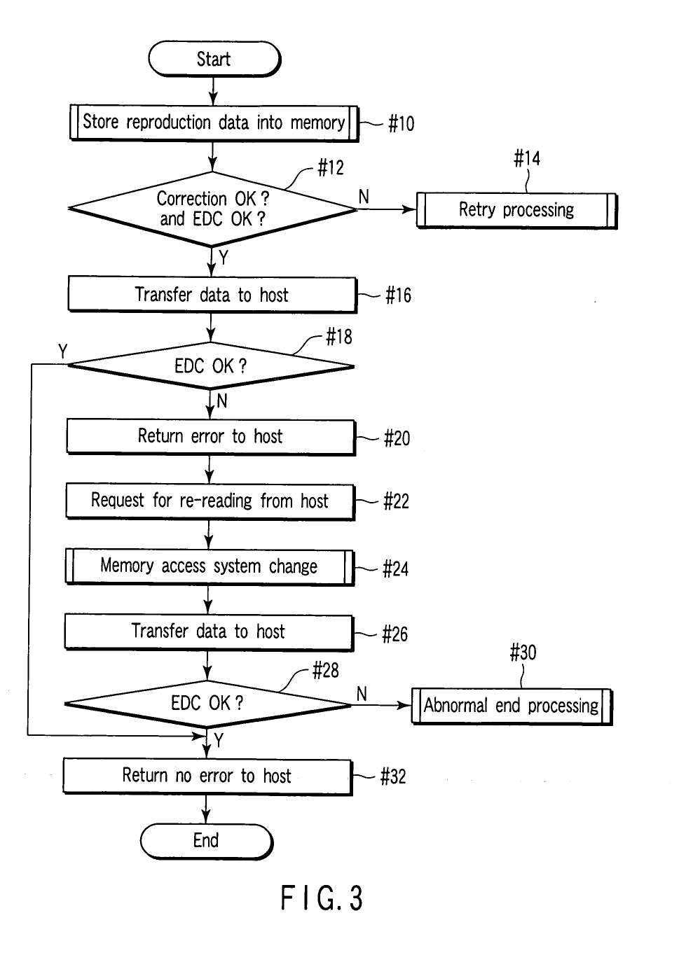

FIG. 3 is a flowchart showing an information processing method according to the embodiment. In a case where there is defined the data frame (or the data sector) 100 including the error detecting parity code EDC 105 attached to the end thereof as shown in, for example, FIG. 2, the information (obtained by demodulating the signal read by an optical head) of this data frame 100 is read from the external (DVD disk 10 or the like), and stored in the memory 5 (the former half of processing at the block #10). If there is an error in the information (demodulation signal or the like) read from the external 10, the error is corrected by the error correction code ECC (the block #10 being processed). It is checked by use of the error detecting parity code EDC 105 whether or not there is the error in the information (information subjected to the ECC correction) of the data frame 100 stored in the memory 5 (the latter half of the processing at the block #10).

When the error correction by the error correction code ECC fails in the ECC processing circuit 1b, or when the error is found by the check using the error detecting parity code EDC 105 in the first EDC circuit 1a (NO at the block #12), reading from the external 10 is retried (block #14). When the error correction by the error correction code ECC does not fail, and the error is not found by the check using the error detecting parity code EDC 105 (YES at the block #12), the information of the data frame 100 stored in the memory 5 is transferred to the host device (PC or the like) 30 (block #16).

The second EDC circuit 2a can check, by use of the error detecting parity code EDC 105, whether or not there is the error in the information of the data frame 100 transferred to the host device 30 (block #18). When the error is found, the information of the data frame 100 is retransferred from the memory 5 to the host device 30 (blocks #20 to #26).

That is, when the error is found in the second EDC circuit 2a (NO at the block #18), an error message is returned to the host device 30 (block #20). Then, the host device 30 requires the memory controller 6 side to reread the information (block #22). Subsequently, the memory controller 6 changes, for example, an access system (or an access method) with respect to the memory 5 (block #24), and retransfers, to the host device 30, the information of the data frame 100 read after the change (block #26). The information retransferred in this manner is checked using the error detecting parity code EDC 105 again in the second EDC circuit 2a (block #28). When the error is found (NO at the block #28), abnormal end process is performed (block #30).

When any error is not found in the information of the data frame 100 transferred to the host device 30 (YES at the block #18), or when any error is not found in the information (information acquired again after the access method is changed) of the data frame 100 retransferred to the host device 30 (YES at the block #28), it is judged that the information has been normally transferred (in other words, it is judged that the information can be transferred with a high reliability), it is notified to the host device 30 that there is not any error (block #32), and the processing ends.

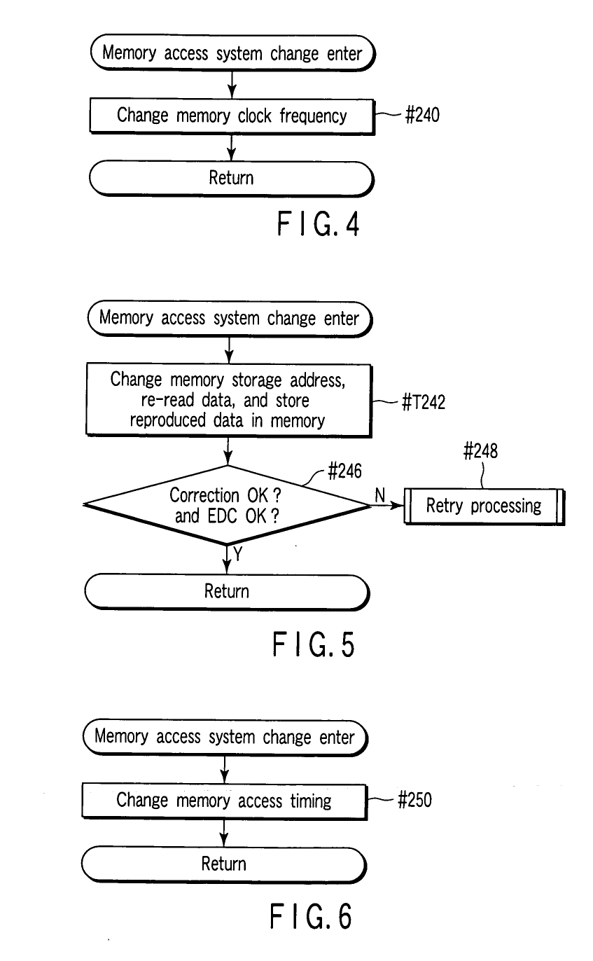

It is to be noted that there are several types of methods during the changing at the block #24. A specific example of the method will be described hereinafter with reference to FIGS. 4 to 6. FIG. 4 is a flowchart showing a specific example (memory clock frequency change) of processing to change a memory access system in the processing method of FIG. 3. In a case where there changes a clock frequency at which the information is read and written with respect to the memory 5, behavior of physical data transmission in the memory interface 4a or the like sometimes slightly changes. Therefore, in a case where the data is changed, if the clock frequency is changed, the data can be prevented from being changed. Therefore, the clock frequency is changed as much as about ±10% (e.g., when the device operates originally at a clock frequency of 100 MHz, the frequency is lowered to 90 MHz), and the information of the data frame 100 is read out from the memory 5 (block #240). In this case, any error may not be found during the error check performed by the second EDC circuit 2a (i.e., any data may not be changed), and normal data transfer is sometimes possible.

In the information processing method of FIG. 3, in a case where the information judged to be correct by the parity check using the EDC (YES at the block #12) is transferred to the external device (host) 30, it is rechecked by the EDC whether or not the error is generated. When there is not any problem in this rechecking, the data may be transferred. However, if the problem is detected (NO at the block #18), the processing is performed again (block #20 to #26). Therefore, high-reliability information can be transferred to the external device.

Instead of the method of FIG. 4 (or when the method of FIG. 4 is tried in vain), there is a method of changing a place of the memory 5 where the information read out from the disk 10 is stored. That is, as shown in FIG. 5, the memory controller 6 sets a memory write address which is different from the previous address, and writes, into the memory 5, the information of the data frame 100 read out from the disk 10 (block #242). In this case, the physical behavior of the information storing/data transmitting sometimes slightly changes in the memory 5 and/or a path from the memory 5 to the memory controller 6. In a case where the data is changed, if the read and write address of the memory 5 is changed, the correction by the ECC may be correctly performed, any error may not be found during the error check performed by the second EDC circuit 2a (i.e., any data may not be changed), and normal data transfer may be sometimes possible (YES at the block #246). It is to be noted that after the memory address is changed, and the information of the data frame 100 is written into the memory 5, the correction by the ECC fails, and/or the error is found during the EDC check (NO at the block #246). In this case, processing to read out the same information from the disk 10 is retried (block #248).

Instead of the method of FIG. 4 or 5 (or in a case where the method of FIG. 4 or 5 is tried in vain), there is a method of changing a timing to access the memory 5. That is, as shown in FIG. 6, a memory access timing (AC timing) is changed (block #250), and the information of the data frame 100 is again read from the disk 10. Thereafter, the data is transferred again to the host device 30 (to the block #26 of FIG. 3). It is to be noted that to change the memory access timing, in a case where a DRAM is used in the memory 5, there may be changed an AC timing of a refresh cycle, CAS latency or the like.

It is to be noted that when a problem is found during the EDC check performed by the second EDC circuit 2a in FIG. 1, the data is transferred again from the memory 5 to the host device 30, and a flow of the transferred data is temporarily discontinued. Even when the flow of the transfer is discontinued during the transfer of computer data, top priority is placed on correctness of the data. Therefore, this temporary discontinuation is accepted. On the other hand, in a case where the data to be transferred is video information (or audio/visual information), even when the data is incorrect, the flow of the data may not be interrupted (specifically, in a case where there is a device design intention indicating that even temporary generation of a block noise in reproduced video is judged to be better than stopping of video being watched). In this case, the EDC check by the second EDC circuit 2a (blocks #18 and #28) is omitted, and the information of the data frame 100 may be transferred from the memory 5 to the external host device 30 without checking whether or not the data is changed in a path from the memory 5 to the host transfer circuit 2.

That is, a constitution in which it is appropriately selected whether or not to perform the EDC check by the second EDC circuit 2a is possible in accordance with contents (computer data or audio/visual information) of the information to be transferred to the host device 30. When the contents of the information to be transferred to the host device 30 are identified, for example, the information of the reserved area 103 of FIG. 2 is usable. Specifically, in a case where there is DVD copyright management information CPR_MAI in this area 103, it is judged that the information to be transferred is the audio/visual information, and the EDC check by the second EDC circuit 2a can be skipped. In the processing of FIG. 3, it is checked at the block #18 whether or not there is copyright management information in the data frame 100. If there is the copyright management information (YES at the block #18), the blocks #20 to #28 can be skipped. Alternatively, since a streaming bit is designated in a read command from the host device 30, the blocks #20 to #28 may be skipped in a case where the streaming bit is set to “1” by the host device 30.

As described above, during the reproduction of the data in the disk reproduction device, when corrected data stored in the memory is transferred to the host, the data is sometimes changed in the interface between the memory and an LSI or in the memory itself. According to the embodiment, such data changing is detected, and high-reliability data transfer is performed.

Specifically, during the disk reproduction, in the device including the EDC check circuit separately disposed in the transfer path of the corrected data from the memory to the host device, when the error is detected in the EDC check during the transfer of the data to the host device, a status indicating that there is the error is returned after completion of the data transfer. In this case, since the host device issues the read command again, the memory access timing or the like is changed, or the memory storage address or the like is changed to read the data from the disk again.

Since the semiconductor (LSI) is miniaturized or the clock frequency rises, the problem of the changed data becomes remarkable in a memory such as the DRAM or the memory interface. However, in this invention, the data changing in the memory and the memory interface is detected, and it is possible to improve the reliability of the data transfer from the drive to the host device.

In the reproduction drive of a disk such as CD-ROM/DVD/HD DVD in which the EDC is included in the data, as shown in FIG. 1, in addition to the first EDC circuit 1a for detecting the erroneous correction, the host transfer circuit 2 includes the second EDC circuit 2a for detecting the data changing in the memory 5 and the memory interface 4a. In a case where the reproduction data is transferred to the host in the device having such circuit constitution, and the error is detected in the second EDC circuit 2a, the status after the completion of the transfer is read, and the error is notified to the host. When the error is notified, the host requires the same data. In a case where there is a request for the data,

<1> the memory clock frequency is changed to transfer the data to the host again;

<2> the memory storage address is changed to read the data from the disk again, and thereafter the data is transferred to the host again; and/or

<3> the memory access timing (AC timing) is changed, the data is read from the disk again, and the data is transferred to the host again. It is to be noted that the memory access timing can be changed by changing the AC timing of the fresh cycle, CAS latency or the like in a case where the DRAM is used.

When any error is not detected in the second EDC circuit 2a by the above method, the transfer processing is completed. When the error is detected, the status indicating the error is returned to the host. When the above procedure is performed, the data error can be detected, and higher-reliability data transfer can be performed, even in a case where trouble occurs in the memory or the memory interface.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing method comprising:
reading information of a data frame from an external to store the information in a memory, the data frame being defined to include an error detecting parity code;
checking by use of the error detecting parity code whether or not there is an error in the information of the data frame stored in the memory;
transferring, to a host, the information of the data frame stored in the memory, when any error is not found by the checking; and
checking by use of the error detecting parity code whether or not there is an error in the information of the data frame transferred to the host, and retransferring the information of the data frame from the memory to the host, when the error is found.

2. An information processing method comprising:
reading information of a data frame from an external to store the information in a memory, the data frame being defined to include an error detecting parity code and data which can be error-corrected by an error correction code;
correcting, when there is an error in the information read from the external, the error by used of the error correction code;
checking by use of the error detecting parity code whether or not there is an error in the information of the data frame stored in the memory;
retrying the reading of the information of the data frame, when the error correction by the error correction code fails or when the error is found by the checking using the error detecting parity code;
transferring, to a host, the information of the data frame stored in the memory, when the error correction by the error correction code does not fail, or when any error is not found by the check using the error detecting parity code; and
checking by use of the error detecting parity code whether or not there is an error in the information of the data frame transferred to the host, and retransferring the information of the data frame from the memory to the host, when the error is found, wherein a processing is terminated, when there is not any error in the information of the data frame transferred to the host or when there is not any error in the information of the data frame retransferred to the host.

3. The information processing method according to claim 2, wherein an abnormal termination processing is performed, when there is the error in the information of the data frame retransferred to the host.

4. The information processing method according to claim 2, further comprising:
changing an access method with respect to the memory, in a case where the information of the data frame is retransferred from the memory to the host.

5. The information processing method according to claim 4, wherein the changing of the access method with respect to the memory includes changing a memory clock frequency.

6. The information processing method according to claim 4, wherein the changing of the access method with respect to the memory includes changing a memory storage address, in a case where the information of the data frame read from the external is stored in the memory.

7. The information processing method according to claim 4, wherein the changing of the access method with respect to the memory includes changing an access timing with respect to the memory.

8. An information processing device comprising:
a memory which stores information of a data frame to which an error detecting parity code is attached;
a first error detection circuit which checks by use of the error detecting parity code whether or not there is an error in the information of the data frame stored in the memory;
a host transfer circuit which transfers, to an external host, the information of the data frame stored in the memory, when any error is not found by the first error detection circuit;
a second error detection circuit which checks by use of the error detecting parity code whether or not there is an error in the information of the data frame transferred to the host; and
a controller which retransfers, to the host, the information of the data frame stored in the memory, when the error is detected by the second error detection circuit.

9. The information processing device according to claim 8, wherein the second error detection circuit checks by use of the error detecting parity code whether or not the error is generated in an information transmission path between the memory and the host transfer circuit.

10. An optical disk drive comprising:
an optical pickup which reads a data frame from an optical disk, the data frame being defined to include an error detecting parity code;
a memory which stores information of the data frame;
a first error detection circuit which checks by use of the error detecting parity code whether or not there is an error in the information of the data frame stored in the memory;
a host transfer circuit which transfers, to an external host, the information of the data frame stored in the memory, when any error is not found by the first error detection circuit;
a second error detection circuit which checks by use of the error detecting parity code whether or not there is an error in the information of the data frame transferred to the host; and
a controller which retransfers, to the host, the information of the data frame stored in the memory, when the error is detected by the second error detection circuit.
